(19) United States
(12) Patent Application Publication
(10) Pub. No.: US 2010/0039507 A1
(43) Pub. Date: Feb. 18, 2010

(54) IMAGE ACQUISITION APPARATUS AND ENDOSCOPE SYSTEM

(75) Inventor: Shinichi Imade, Saitama (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 12/501,914

(22) Filed: Jul. 13, 2009

(30) Foreign Application Priority Data
Aug. 13, 2008 (JP) 2008-208420

(51) Int. Cl. H04N 7/18; G06K 9/00

(52) U.S. Cl. 348/68; 382/167; 382/128; 348/E07.085

(57) ABSTRACT

An object is to provide an image acquisition apparatus that can acquire an image having a tint substantially equal to that of an image acquired with reference light having a flat color distribution even when the color distribution of illumination light is not uniform, and to provide an endoscope system including such an image acquisition apparatus. The image acquisition apparatus includes an LED unit that emits observation light illuminating an examination site; an image-acquisition element that acquires an image of the examination site illuminated by the observation light; a correction-coefficient recording section that stores a correction coefficient for making the color distribution of first image information acquired by the image-acquisition element with the emitted observation light approximate the color distribution of second image information acquired by the image-acquisition element with emitted reference light having a flat color distribution; a video-signal processing section that corrects the color distribution of the first image information using the correction coefficient stored in the correction-coefficient recording section; and a display monitor that displays the first image information corrected by the video-signal processing section.

### BACKGROUND OF THE INVENTION

1. Field of the Invention

The present invention relates to an image acquisition apparatus that acquires an image of an illuminated examination site and to an endoscope system provided with such an image acquisition apparatus.

This application is based on Japanese Patent Application No. 2008-208420, the content of which is incorporated herein by reference.

2. Description of Related Art

With the enhancement of luminous efficiency and practical realization of high-intensity white light LEDs and high-intensity RGB primary light source devices, semiconductor light sources including light-emitting diodes (hereinafter, referred to as “LEDs”) and semiconductor lasers are being employed as illumination light sources for image display systems, such as large-screen liquid crystal televisions and projectors, which were once considered difficult to realize due to their insufficient brightness. Also, for light sources of medical equipment such as endoscopes and microscopes, existing xenon lamps, halogen lamps, and metal halide lamps are being replaced with white-light LEDs or RGB primary LEDs. Because of their features, including extended service life, low power consumption, easy control of light intensity, and a low environmental load due to the absence of mercury, LEDs are expected to serve as useful light sources.

When LED light sources are to be adopted, for example, as medical endoscope light sources that require a high-fidelity color tone, it is difficult to acquire images with a high degree of color rendering due to non-uniform color distribution of the illumination light.

Well-known techniques for overcoming this problem include a method of correcting color balance so that the acquired RGB components of an illuminated white subject become uniform (e.g., refer to Japanese Unexamined Patent Application, Publication No. Sho 63-267091); a method of performing correction so that the integral of the color-difference signal of the entire image becomes equal to zero (e.g., refer to Japanese Unexamined Patent Application, Publication No. Hei 10-150671); and a method of providing a detection unit configured to detect the color distribution of illumination light, identifying a color temperature from the detected value, and correcting it to a desired color temperature (e.g., refer to Japanese Unexamined Patent Application, Publication No. 2003-296720).

According to the above-described methods, it is possible to obtain a white-balance image of a white (and only a white) subject, for example, by correcting illumination light that lacks a flat color distribution by the use of the white subject. However, because actual subjects do not have uniform spectral reflectance characteristics, it is not always possible to obtain a white-balance image.

In addition, for endoscope systems, the tint of an observed image, whether it is associated with normal tissue or diseased tissue, is desirably represented with color reproduction similar to that of xenon lamp illumination, which has a flat color distribution. However, in the case of non-flat spectrum illumination, for example, that of a white LED light source, to uniformly adjust the acquired RGB image data with the same gain will probably fail in color correction for satisfying both normal tissue and diseased tissue having different spectral reflectance characteristics.

### BRIEF SUMMARY OF THE INVENTION

The present invention has been conceived in light of the above-described circumstances, and an object thereof is to provide an image acquisition apparatus that, despite using illumination light with non-uniform color distribution, can acquire an image having a tint substantially equal to the tint of an image that would be acquired with reference light having a flat color distribution, and also to provide an endoscope system including such an image acquisition apparatus.

In order to achieve the above-described object, the present invention provides the following solutions.

A first aspect of the present invention is an image acquisition apparatus including an observation light source configured to emit observation light that illuminates an examination site; an image-acquisition section configured to acquire an image of the examination site illuminated by the observation light emitted from the observation light source; a correction-coefficient storing section configured to store at least one correction coefficient for making a color distribution of first image information acquired by the image-acquisition section with the emitted observation light approximate a color distribution of second image information acquired by the image-acquisition section with emitted reference light having a flat color distribution; an image-information correcting section configured to correct the color distribution of the first image information using the at least one correction coefficient stored in the correction-coefficient storing section; and a display section configured to display the first image information corrected by the image-information correcting section.

According to the first aspect of the present invention, the color distribution of the first image information is corrected by the image-information correcting section using the correction coefficient for making the color distribution of the first image information acquired by the image-acquisition section as a result of the examination site being illuminated with observation light from the observation light source approximate the color distribution of the second image information acquired by the image-acquisition section with the illumination of the reference light having the flat color distribution, and the corrected first image information is displayed on the display section.

By doing so, the first image information acquired with emitted observation light having a non-uniform color distribution can be corrected to have a tint equal to that of the second image information acquired with emitted reference light having a flat color distribution and be displayed on the display section.

The above-described image acquisition apparatus may further include a correction-coefficient calculating section configured to calculate the at least one correction coefficient using the first image information and the second image information.

By doing so, because a correction coefficient for making the color distribution of the first image information approximate the color distribution of the actually acquired second image information is calculated by the correction-coefficient calculating section, the first image information can be corrected to have a tint equal to that of the second image information using the calculated correction coefficient.

In the above-described image acquisition apparatus, the at least one correction coefficient may be a coefficient that minimizes a difference between the color distribution of the first image information and the color distribution of the second image information.

Because the correction coefficient for minimizing the difference between the color distribution of first image information and the color distribution of the second image information is used, the color distribution of the first image information can be made to substantially match the color distribution of the second image information.

In the above-described image acquisition apparatus, the at least one correction coefficient may include a first correction coefficient for correcting a color distribution of image information of normal tissue in a living organism and a second correction coefficient for correcting a color distribution of image information of diseased tissue in the living organism, and the image-information correcting section may correct the color distribution of the first image information using one of the first correction coefficient and the second correction coefficient.

Because the first correction coefficient and the second correction coefficient that respectively correspond to the normal tissue and the diseased tissue having different spectral reflectance characteristics are stored in the correction-coefficient storing section, the first correction coefficient and the second correction coefficient can be used selectively according to the examination site, and therefore, correction appropriate for each of the normal tissue and the diseased tissue can be performed on the first image information.

The above-described image acquisition apparatus may further include an image identifying section configured to discriminate between the normal tissue and the diseased tissue, wherein the image-information correcting section may correct the color distribution of the first image information using the first correction coefficient if the image identifying section identifies the normal tissue or may correct the color distribution of the first image information using the second correction coefficient if the image identifying section identifies the diseased tissue.

By doing so, because the image identifying section determines whether the examination site is normal tissue or diseased tissue, the color distribution of the first image information can be corrected using the correction coefficient appropriate for the identified examination site.

In the above-described image acquisition apparatus, the image identifying section may discriminate between the normal tissue and the diseased tissue for one predetermined area at a time, and the image-information correcting section may correct the color distribution of the first image information for each of the predetermined areas at a time.

By doing so, because the color distribution of the first image information can be corrected using the correction coefficient appropriate for the examination site individually for each predetermined area, rather than for the entire image, the first image information can be corrected more accurately to have a tint equal to that of the second image information.

In the above-described image acquisition apparatus, the image identifying section may discriminate between the normal tissue and the diseased tissue using a third correction coefficient for correcting the image information of the normal tissue and above-described image information of the diseased tissue so as to produce different color distributions.

By doing so, the normal tissue and the diseased tissue are identified with high accuracy, and the color distribution of the first image information can be corrected using the correction coefficient appropriate for the identified examination site.

In the above-described image acquisition apparatus, the third correction coefficient may be a coefficient for highlighting a blue narrow-band component and a green narrow-band component.

Normal tissue can be discriminated from diseased tissue more accurately by using such a third correction coefficient.

In the above-described image acquisition apparatus, the observation light source may include a plurality of light source elements that are arranged in the shape of a ring and emit observation light in an inward radial direction of the ring; a light guide section configured to guide observation light emitted from the light source elements in a direction parallel to a central axis of the ring; a rotating section configured to rotationally drive the light guide section about the central axis; and a control section configured to control illumination of the light source elements and rotation of the rotating section.

By doing so, the examination site is illuminated with pseudo white light in the form of superimposed beams of observation light from the light source elements, and the color distribution of the first image information acquired with this emitted pseudo white light can be corrected to have a tint equal to that of the second image information acquired with the emitted reference light having a flat color distribution.

A second aspect of the present invention is an endoscope system including any one of the above-described image acquisition apparatuses and a scope configured to guide the observation light to the examination site.

According to such an endoscope system, because an image acquired with emitted observation light can be viewed with a tint equal to that of an image acquired with emitted reference light, the accuracy of tint-based diagnosis can be enhanced.

According to the present invention, even when illumination light has a non-uniform color distribution, an image with a tint substantially equal to that of an image acquired with reference light having a flat color distribution can be acquired.

### BRIEF DESCRIPTION OF THE SEVERAL VIEWS OF THE DRAWINGS

FIG. 1 is a block diagram depicting the schematic structure of an endoscope system according to a first embodiment.

FIG. 2 is an enlarged partial view of the structure of a light-path switching section in FIG. 1.

FIG. 3 is a block diagram depicting the functions of a video-signal processing section in FIG. 1.

FIGS. 4A to 4G are graphs showing a color distribution obtained when a subject is illuminated by observation light, where FIG. 4A shows the spectral distribution of the observation light, FIG. 4B shows the spectral reflectance distribution of the subject, FIG. 4C shows the spectral distribution of reflected light resulting when the subject is illuminated by the observation light, FIG. 4D shows color distribution characteristics of a color filter, FIG. 4E shows the spectral distribution of the R component, FIG. 4F shows the spectral distribution of the G component, and FIG. 4G shows the spectral distribution of the B component.

FIGS. 5A and 5B are diagrams depicting pixel coordinates, where FIG. 5A is associated with a monochrome image-acquisition element and FIG. 5B is associated with a color image-acquisition element.

FIG. 6 is a diagram for illustrating a method of calculating correction coefficients.

FIG. 7 is a diagram for illustrating a method of calculating a correction coefficient for the R component.

FIG. 8 is a flowchart for illustrating a method of calculating correction coefficients.

FIG. 9 is a flowchart for illustrating a method of correcting an image.

FIG. 10 is a block diagram depicting the schematic structure of an endoscope system according to a second embodiment.

FIG. 11 is a flowchart for illustrating a method of calculating correction coefficients and a method of correcting an image.

FIG. 12 is a schematic diagram depicting the schematic structure of an endoscope system according to a third embodiment.

FIG. 13 is a longitudinal sectional view of an illumination device in FIG. 12.

FIG. 14 is a diagram for illustrating the relationship between the rotational angle of a light guide member and the output level of observation light.

FIG. 15 is a graph depicting the spectral distribution of observation light.

FIG. 16 is a graph depicting the spectral distribution of observation light.

FIG. 17 is a diagram for illustrating a method of calculating correction coefficients for an endoscope system according to a fourth embodiment.

FIG. 18 is a block diagram depicting the schematic structure of an endoscope system according to a fifth embodiment.

FIG. 19 is a block diagram depicting a modification of the endoscope system in FIG. 18.

FIG. 20 is a block diagram depicting the schematic structure of an endoscope system according to a sixth embodiment.

### DETAILED DESCRIPTION OF THE INVENTION

### First Embodiment

An image acquisition apparatus according to a first embodiment of the present invention will now be described with reference to the drawings. In the current description, it is assumed that the image acquisition apparatus according to the present invention is applied to an endoscope system.

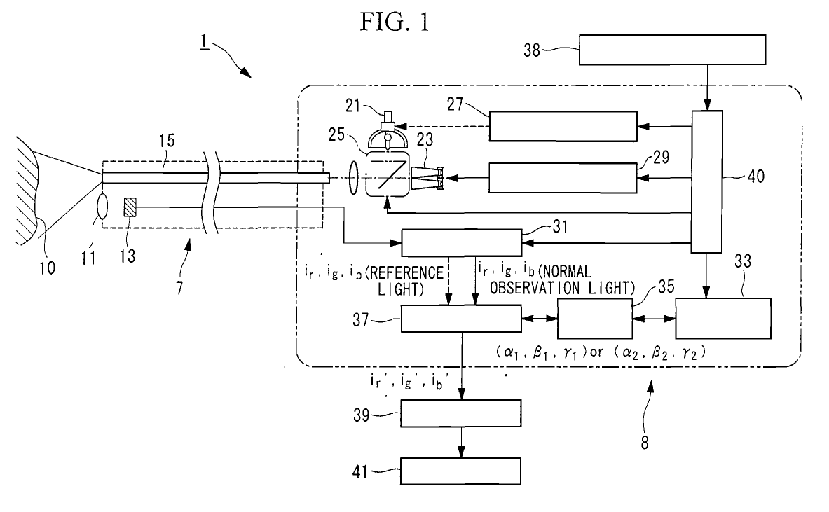

FIG. 1 is a block diagram depicting the schematic structure of the endoscope system according to this embodiment.

Referring to FIG. 1, an endoscope system 1 according to this embodiment includes, for example, a scope 7 that is inserted into a body cavity and acquires a video signal of an examination site 10 and a video-signal processing apparatus 8 that emits observation light towards the examination site 10 via the scope 7 and processes the video signal of the examination site 10 acquired by the scope 7.

The scope 7 includes an image-acquisition lens 11 disposed at the distal end thereof; an image-acquisition element 13 that is disposed at a rear part on the optical axis of the image-acquisition lens 11 and acquires a video signal of the examination site 10; and a lightguide 15 that extends all the distance along the longitudinal direction of the scope 7 from the base to the distal end of the scope 7 and guides observation light emitted by the video-signal processing apparatus 8 onto the examination site 10.

The video-signal processing apparatus 8 includes a white lamp (reference light source) 21; an LED unit (observation light source) 23; a light-path switching section 25 that switches the light path between the white lamp 21 and the LED unit 23; a lamp-drive control section 27 that controls the driving of the white lamp 21; an LED-drive control section 29 that controls the driving of the LED unit 23; an image-acquisition element control section 31 that controls the image-acquisition element 13; a correction-coefficient recording section (correction-coefficient storing section) 33 that records correction coefficients for correcting the color distribution of the video signal acquired by the image-acquisition element 13; a correction-coefficient selecting section 35 that selects correction coefficients recorded in the correction-coefficient recording section 33; a video-signal processing section (image-information correcting section) 37 that uses the correction coefficients selected by the correction-coefficient selecting section 35 to correct the color distribution of the video signal acquired by the image-acquisition element 13; a display-signal processing section 39 that performs processing for displaying the video signal corrected by the video-signal processing section 37; a display monitor (display section) 41 that displays the video signal processed by the display-signal processing section 39; a correction-mode-switching instructing section 38 that switches the correction mode of the video-signal processing section 37 according to the examination site 10; and a system control section 40 that controls these sections.

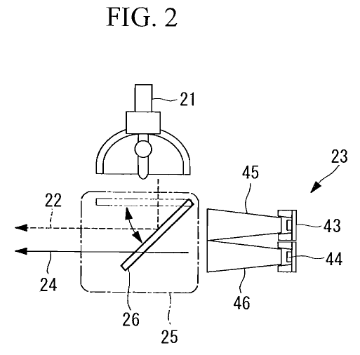

FIG. 2 is an enlarged view of the white lamp 21, the LED unit 23, and the light-path switching section 25.

The white lamp 21 is, for example, a xenon lamp and emits reference light 22 having a flat color distribution towards the light-path switching section 25.

The LED unit 23 emits observation light 24 having a color distribution different from that of the white lamp 21 towards the light-path switching section 25. The LED unit 23 includes a substrate 43; an LED (semiconductor light source) 44 that is secured to the substrate 43 and emits the observation light 24; a tapered rod 45 that guides the observation light 24 emitted from the LED 44; and a reflecting member 46 that reflects the observation light 24 emitted from the LED 44 into the tapered rod 45.

The light-path switching section 25 includes a movable reflector plate 26 and guides one of the reference light 22 and the observation light 24 onto the incident surface of the lightguide 15 by operating the reflector plate 26.

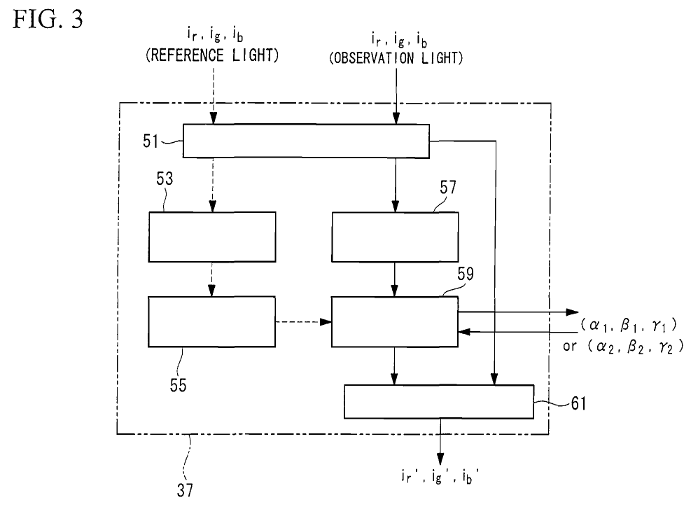

FIG. 3 is a block diagram depicting specific functions of the video-signal processing section 37.

Referring to FIG. 3, the video-signal processing section 37 includes a video-data producing section 51 that generates video data from the video signal acquired by the image-acquisition element 13; a pixel-output-distribution calculating section A 53 that calculates a pixel output distribution of the video signal (second image information) acquired by the image-acquisition element 13 with the emitted reference light 22; a distribution-data recording section 55 that records distribution data calculated by the pixel-output-distribution calculating section A 53; a pixel-output-distribution calculating section B 57 that calculates a pixel output distribution of the video signal (first image information) acquired by the image-acquisition element 13 with the emitted observation light 24; a correction-coefficient calculating section 59 that calculates correction coefficients using the distribution data calculated by the pixel-output-distribution calculating section B 57 and the distribution data recorded in the distribution-data recording section 55; and a correction-video-data producing section 61 that uses the correction coefficients calculated by the correction-coefficient calculating section 59 to correct the video signal acquired by the image-acquisition element 13 with the emitted observation light 24.

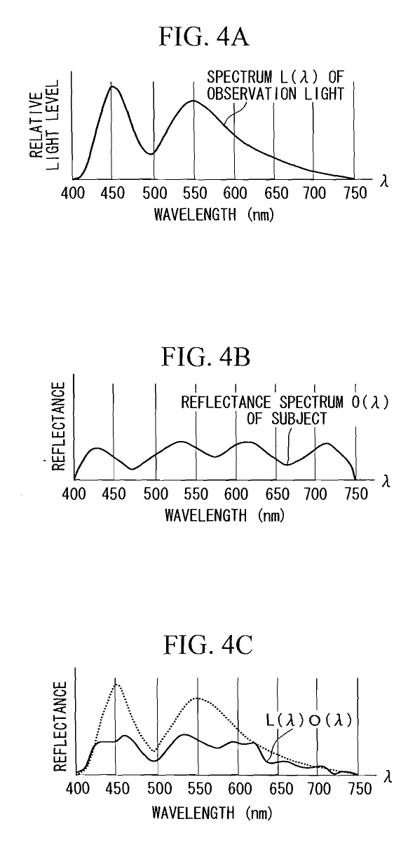

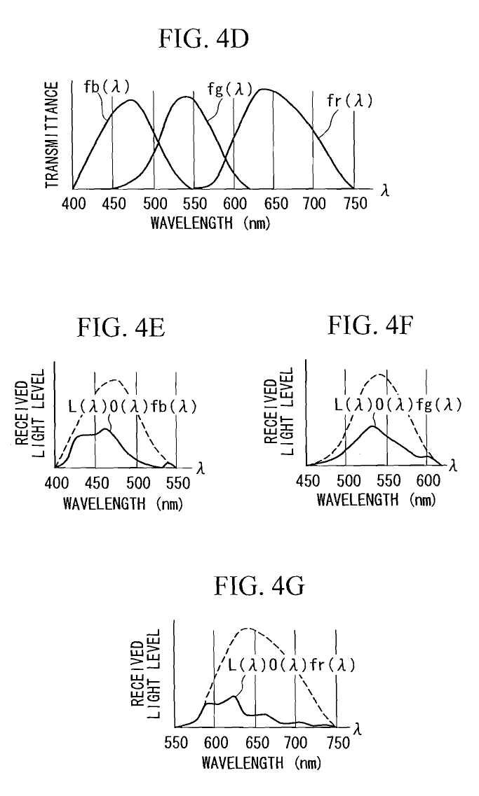

A detailed method of calculating correction coefficients by the correction-coefficient calculating section 59 will be described with reference to the examples shown in FIGS. 4A to 4G.

FIG. 4A shows one example of the spectral distribution of the observation light 24. As shown in FIG. 4A, the observation light 24 has a non-uniform spectral distribution; specifically, the relative light level is higher near the wavelengths of 450 nm and 550 nm.

FIG. 4B shows one example of the spectral distribution of reflected light resulting when a subject is illuminated by the reference light 22 having a flat spectral distribution. As shown in FIG. 4B, the light reflected from the subject exhibits reflectances that differ depending on the wavelength range.

FIG. 4C shows the spectral distribution of reflected light resulting when the subject having the spectral reflectance characteristics shown in FIG. 4B is illuminated by the observation light 24 shown in FIG. 4A. As shown in FIG. 4C, the light reflected from the subject, representing the product of the spectral distribution of the observation light 24 and the spectral reflectance characteristics of the subject, has a reflectance that considerably fluctuates depending on the wavelength range. The dotted line in FIG. 4C represents the spectral distribution of the observation light 24 shown in FIG. 4A.

FIGS. 4E, 4F, and 4G show the received light levels of the R, G, and B color components produced by splitting reflected light having the spectral distribution shown in FIG. 4C via a color filter having the color distribution characteristics shown in FIG. 4D. More specifically, the received light levels iᵣ, i_{g}, and i_{b} of the respective R, G, and B color components are calculated based on Expressions (1), (2), and (3) below:

$$\begin{matrix}{i}_{r} = {\int }_{- ∞}^{+ ∞} L ( λ ) O ( λ ) fr ( λ ) d ( λ ) & ( 1 ) \\ {i}_{g} = {\int }_{- ∞}^{+ ∞} L ( λ ) O ( λ ) fg ( λ ) d ( λ ) & ( 2 ) \\ {i}_{b} = {\int }_{- ∞}^{+ ∞} L ( λ ) O ( λ ) fb ( λ ) d ( λ ) & ( 3 )\end{matrix}$$

As shown in FIGS. 4E, 4F, and 4G, each of the color components exhibits a non-uniform distribution. Therefore, when the subject is illuminated by the observation light 24, a tint that differs from the tint obtained when the subject is illuminated with the reference light 22 having a flat spectral distribution is produced.

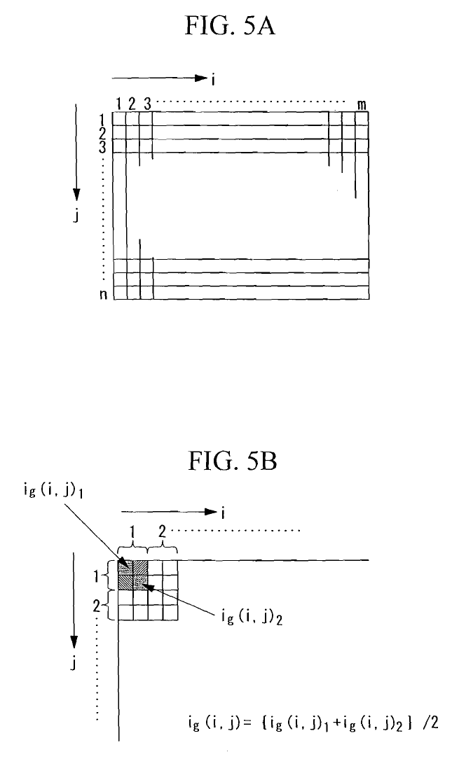

To overcome this problem, it is necessary to correct the color distribution individually for groups consisting of a predetermined number of pixels, as shown in FIG. 5A or FIG. 5B. FIG. 5A shows pixel coordinates of a monochrome image-acquisition element, and FIG. 5B shows pixel coordinates of a color image-acquisition element. In the example of FIG. 5B, the tints of four pixels grouped into one area are averaged to obtain the tint of that area.

The tint of each predetermined group of pixels calculated in this manner is normalized so that the maximum tint value for each of the R, G, and B color components is equal to one, using Expressions (4) and (5).

M={max[iᵣ(i, j), i_{g}(i, j), i_{b}(i, j))]|1≦i≦m, 1≦j≦n} (4)

Ir(i, j)=iᵣ(i, j)/M, Ig(i, j)=i_{g}(i, j)/M, Ib(i, j)=i_{b}(i, j)/M (5)

Therefore, 0≦Ir(i, j)≦1, 0≦Ig(i, j)≦1, and 0≦Ib(i, j)≦1.

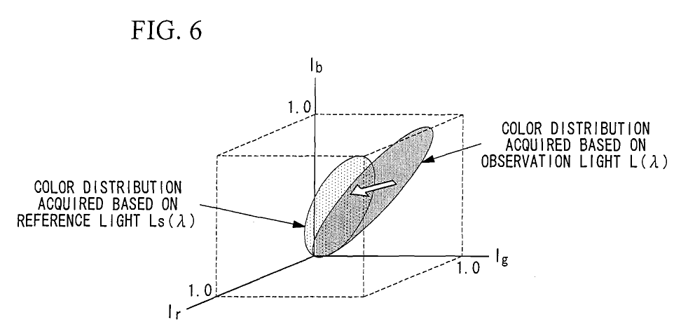

Next, as shown in FIG. 6, correction coefficients that would cause the color distribution acquired based on observation light L(λ) to become equal to the color distribution acquired based on reference light Ls(λ) are calculated for the normalized values Ir, Ig, and Ib of these color components.

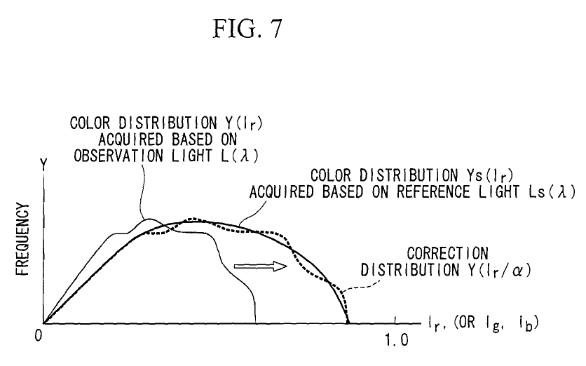

FIG. 7 shows an example where a correction coefficient α for making the color distribution Y(Ir) acquired based on the observation light L(λ) approximate the color distribution Ys(Ir) acquired based on the reference light Ls(λ) is calculated for the R component. As shown in FIG. 7, a correction coefficient α that produces the minimum error area between correction distribution Y(Ir/α), which is a value a times the color distribution Y(Ir) acquired based on the observation light L(λ), and the color distribution Ys(Ir) acquired based on the reference light Ls(λ) is calculated. More specifically, a correction coefficient α that minimizes the value of Expression (6) is calculated. In the same manner, correction coefficients β and γ that would minimize the values of Expressions (7) and (8), respectively, are calculated also for the G and B components.

$$\begin{matrix}{\int }_{0}^{1.0} \vert Ys ( Ir ) - Y ( Ir / α ) \vert d Ir & ( 6 ) \\ {\int }_{0}^{1.0} \vert Ys ( Ig ) - Y ( Ig / β ) \vert d Ig & ( 7 ) \\ {\int }_{0}^{1.0} \vert Ys ( Ib ) - Y ( Ib / γ ) \vert d Ib & ( 8 )\end{matrix}$$

The received light levels iᵣ, i_{g}, and i_{b} of the color components are multiplied by the correction coefficients α, β, and γ of the color components calculated in this manner, as shown in Expressions (9-1) to (9-3), to correct the color components.

iᵣ′=αiᵣ (9-1)

i_{g}′=βi_{g} (9-2)

i_{b}′=γi_{b} (9-3)

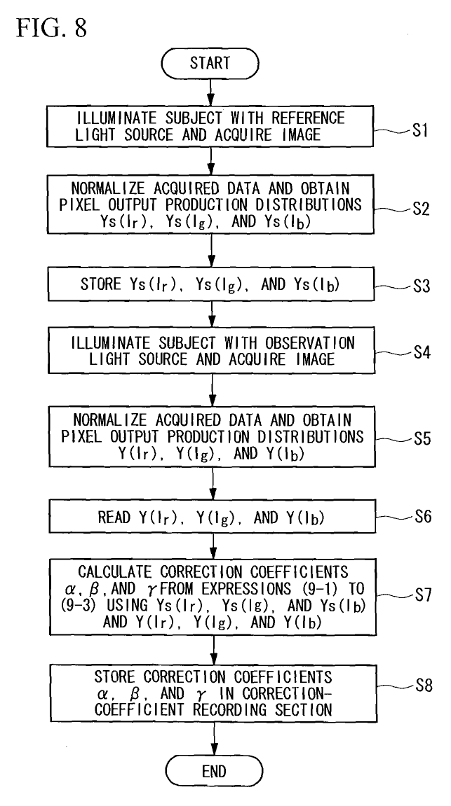

The above-described method of calculating correction coefficients will be described with reference to the flowchart shown in FIG. 8.

First, the white lamp 21 (reference light source) illuminates the subject with the reference light 22, and the image-acquisition element 13 performs image acquisition (S1).

Next, the data obtained by image acquisition is normalized separately for each of the R, G, and B color components, and pixel output production distributions Ys(Ir), Ys(Ig), and Ys(Ib) are calculated by the pixel-output-distribution calculating section A 53 (S2). The pixel output production distributions Ys(Ir), Ys(Ig), and Ys(Ib) calculated in this manner are then stored in the distribution-data recording section 55 (S3).

The above-described processing from S1 to S3 need not be performed for every examination of the examination site but may be performed only once in advance.

Next, the LED unit 23 (observation light source) illuminates the subject with the observation light 24, and the image-acquisition element 13 performs image acquisition (S4).

Then, the data obtained by image acquisition is normalized separately for each of the R, G, and B color components, and pixel output production distributions Y(Ir), Y(Ig), and Y(Ib) are calculated by the pixel-output-distribution calculating section B 57 (S5). The pixel output production distributions Y(Ir), Y(Ig), and Y(Ib) calculated in this manner are read by the correction-coefficient calculating section 59 (S6).

Next, the correction-coefficient calculating section 59 calculates the correction coefficients α, β, and γ using the pixel output production distributions Ys(Ir), Ys(Ig), and Ys(Ib) stored in the distribution-data recording section 55; the read pixel output production distributions Y(Ir), Y(Ig), and Y(Ib); and the above-described Expressions (9-1) to (9-3) (S7).

Thereafter, the correction coefficients α, β, and γ calculated in this manner are recorded in the correction-coefficient recording section 33 (S8).

The process of calculating the above-described correction coefficients needs to be performed for the case where the subject is normal tissue in a living organism, as well as for the case where the subject is diseased tissue in a living organism. The following description assumes that correction coefficients for correcting the color distribution of the video signal from normal tissue are first correction coefficients α₁, β₁, and γ₁ and that correction coefficients for correcting the color distribution of the video signal from diseased tissue are second correction coefficients α₂, β₂, and γ₂.

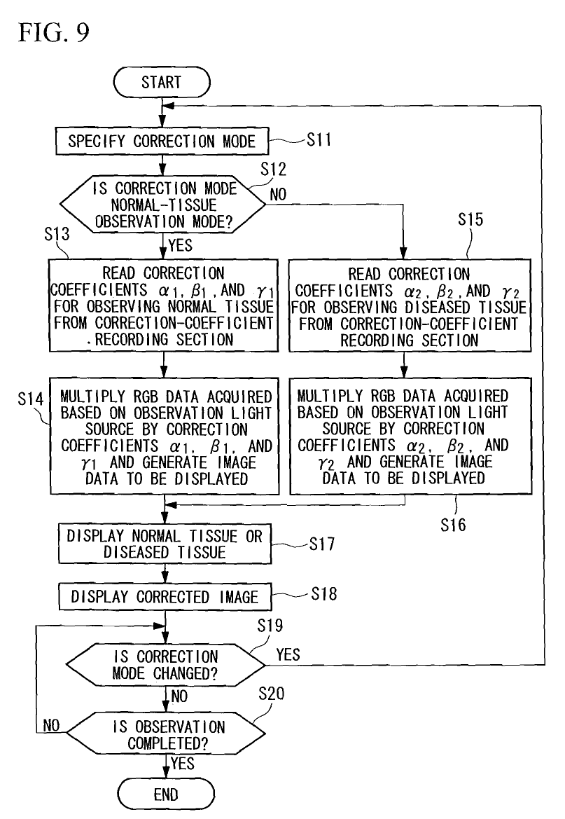

Processing that is performed when the video signal acquired at the time of examination is to be corrected using the correction coefficients calculated as described above will be described with reference to the flowchart shown in FIG. 9.

First, either a normal-tissue observation mode or a diseased-tissue observation mode is specified as the correction mode according to the examination site 10 via the correction-mode-switching instructing section 38 (S11).

When the specified correction mode is the normal-tissue observation mode (S12), the first correction coefficients α₁, β₁, and γ₁ for examining normal tissue are read by the video-signal processing section 37 from the correction-coefficient recording section 33 (S13). Thereafter, the R, G, and B color components of the video signal from normal tissue are corrected by the video-signal processing section 37 using the respective first correction coefficients α₁, β₁, and γ₁ that have been read, and image data to be displayed is then generated (S14).

On the other hand, when the specified correction mode is the diseased-tissue observation mode (S12), the second correction coefficients α₂, β₂, and γ₂ for examining diseased tissue are read by the video-signal processing section 37 from the correction-coefficient recording section 33 (S15). Then, the R, G, and B color components of the video signal from diseased tissue are corrected by the video-signal processing section 37 using the respective second correction coefficients α₂, β₂, and γ₂ that have been read, and image data to be displayed is then generated (S16).

Not only is the correction process performed as described above indicated in the form of whether the correction is associated with normal tissue or diseased tissue (S17), but also the corrected image of normal tissue or diseased tissue is displayed on the display monitor 41 (S18). Thereafter, the flow returns to S11 when the correction mode is changed (S19), or the current correction mode continues until the examination is completed when the correction mode is not changed (S20).

As described above, according to the endoscope system 1 of this embodiment, a video signal acquired as a result of illumination with the observation light 24 having a non-uniform color distribution can be corrected so as to produce a tint that is substantially equal to the tint of a video signal that would be acquired as a result of illumination with the reference light 22 having a flat color distribution, and the video signal with that corrected tint can be displayed on the display monitor 41.

Furthermore, the first group of correction coefficients α₁, β₁, and γ₁ and the second group of correction coefficients α₂, β₂, and γ₂ that respectively correspond to normal tissue and diseased tissue having different spectral reflectance characteristics can be stored in the correction-coefficient recording section 33 to selectively use these correction coefficients according to the examination site 10, thereby allowing correction appropriate for normal tissue or diseased tissue to be performed on the video signal acquired by illumination with the observation light 24.

### Second Embodiment

Next, an endoscope system according to a second embodiment of the present invention will be described with reference to the drawings.

An endoscope system 2 according to this embodiment differs from the endoscope system 1 according to the first embodiment in that a function for recording illumination data of the reference light and a function for performing fine adjustment of correction coefficients are additionally provided. For the endoscope system 2 of this embodiment, a description of the same points as those in the first embodiment will be omitted, and points different from those in the first embodiment will be mainly described.

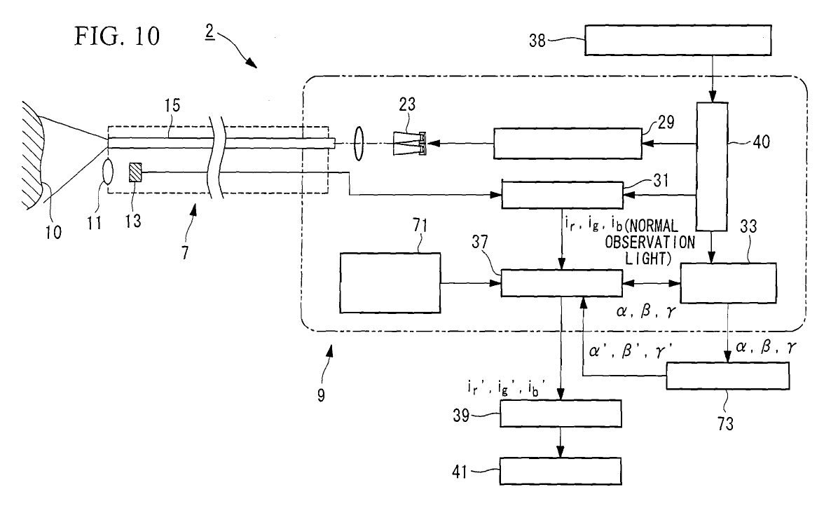

Referring to FIG. 10, in addition to the components shown in FIG. 1, the endoscope system 2 according to this embodiment includes a reference-light image-acquisition-color-distribution recording section 71 that records the color distribution acquired with the emitted reference light 22 and a fine-adjustment operating section 73 that performs fine adjustment of the correction coefficients recorded in the correction-coefficient recording section 33. Furthermore, the endoscope system 2 does not include the white lamp 21, the light-path switching section 25, and the lamp-drive control section 27 shown in FIG. 1.

The reference-light image-acquisition-color-distribution recording section 71 records the color distribution of the video signal acquired by the image-acquisition element 13 with the emitted reference light 22. This color distribution may be acquired by the image-acquisition element 13 by illuminating the subject with the reference light 22 from the white lamp 21 that is provided separately from the endoscope system 2 or may be acquired directly via an external interface (not shown in the figure) from an external memory that records color distribution data.

The fine-adjustment operating section 73 is a user-operable operating section such as a knob, which allows correction coefficients to be changed according to the user's preference to adjust the tint of the image displayed on the display monitor 41.

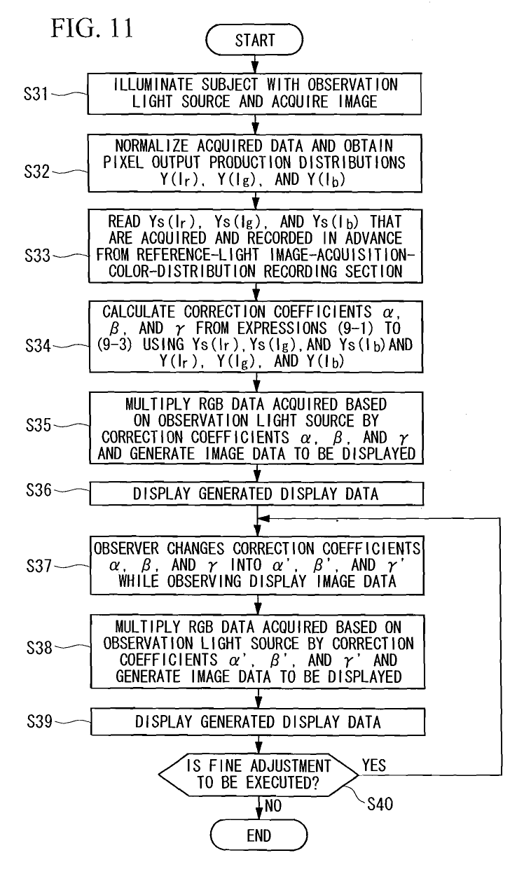

In the endoscope system 2 with the above-described structure, processing for calculating correction coefficients and processing for correcting a video signal will be described with reference to the flowchart shown in FIG. 11.

First, as prerequisites, data acquired by illuminating the subject with the reference light 22 needs to be recorded in the reference-light image-acquisition-color-distribution recording section 71; and the pixel output production distributions Ys(Ir), Ys(Ig), and Ys(Ib) for the R, G, and B color components calculated based on this data by the pixel-output-distribution calculating section A 53 need to be stored in the distribution-data recording section 55.

In the above-described state, the subject is illuminated with the observation light from the LED unit 23, and image acquisition is performed by the image-acquisition element 13 (S31).

Next, the acquired data is normalized for each of the R, G, and B color components, and the pixel output production distributions Y(Ir), Y(Ig), and Y(Ib) are calculated by the pixel-output-distribution calculating section B 57 (S32). The distributions Ys(Ir), Ys(Ig), and Ys(Ib) calculated in this manner are read by the correction-coefficient calculating section 59 (S33).

Next, the correction-coefficient calculating section 59 calculates the correction coefficients α, β, and γ using the distributions Ys(Ir), Ys(Ig), and Ys(Ib) recorded in the distribution-data recording section 55; the read distributions Y(Ir), Y(Ig), and Y(Ib); and the above-described Expressions (9-1) to (9-3) (S34).

Next, the video signal of the examination site is corrected by the video-signal processing section 37 for each of the R, G, and B color components using the correction coefficients α, β, and γ, and image data to be displayed is generated (S35).

Then, the image of the examination site corrected in this manner is displayed on the display monitor 41 (S36).

Next, when an observer operates the fine-adjustment operating section 73 while observing the displayed image data, the correction coefficients α, β, and γ are changed into correction coefficients α′, β′, and γ′ (S37).

Next, the video-signal processing section 37 corrects the video signal of the examination site for each of the R, G, and B color components using the correction coefficients α′, β′, and γ′, and image data to be displayed is generated (S38).

Then, the image of the examination site corrected in this manner is displayed on the display monitor 41 (S39).

The processing in the above-described steps S37 to S39 is repeated until the image displayed on the display monitor 41 exhibits a tint desired by the observer (S40).

As described above, according to the endoscope system 2 of this embodiment, the white lamp 21, the light-path switching section 25, and the lamp-drive control section 27 can be omitted from the structure by providing the reference-light image-acquisition-color-distribution recording section 71. Furthermore, the tint of the image displayed on the display monitor 41 can be adjusted according to the user's preference by providing the fine-adjustment operating section 73.

The correction coefficients fine-adjusted by the user may be recorded for reuse. For example, user-specific IDs may be set so that when an ID is entered, correction coefficients previously adjusted by the corresponding user can be read out, thereby simplifying color adjustment work by the user.

### Third Embodiment

An endoscope system according to a third embodiment of the present invention will be described with reference to the drawings.

An endoscope system 3 according to this embodiment differs from the endoscope systems in the above-described embodiments in that an illumination device 80 composed of a plurality of LED units 23 disposed in a ring shape is provided as the observation light source. For the endoscope system 3 of this embodiment, a description of the same points as those in the above embodiments will be omitted, and points different from those in the above embodiments will be mainly described.

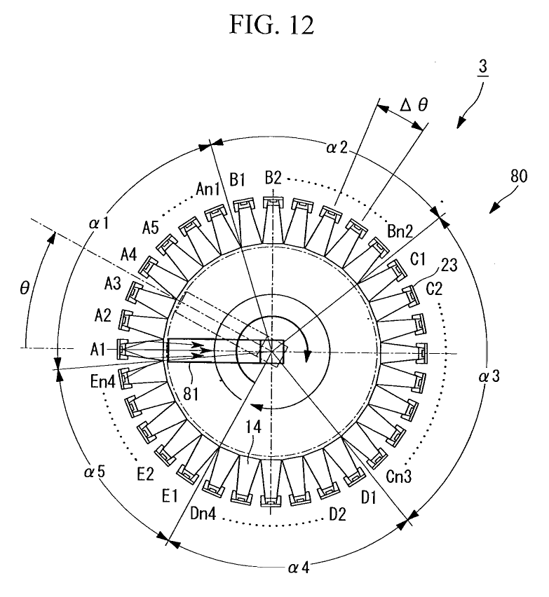

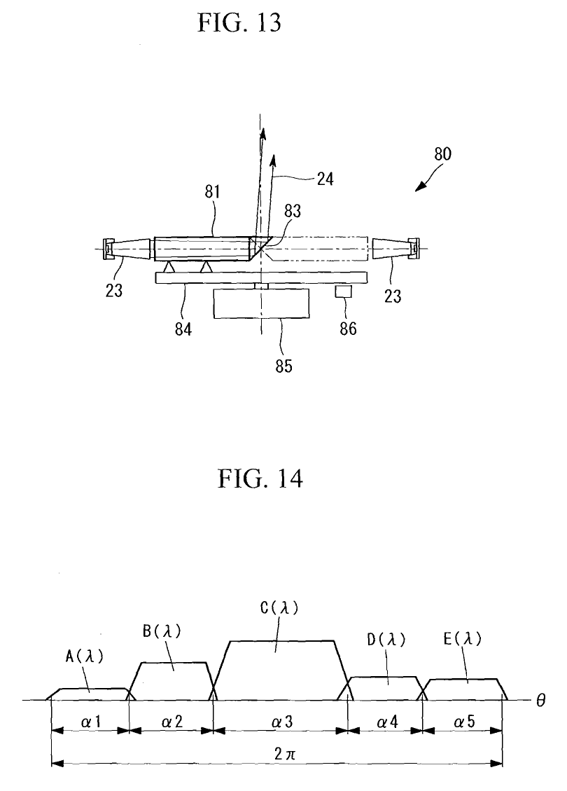

FIGS. 12 and 13 are schematic diagrams depicting the structure of the illumination device 80 of this embodiment. FIG. 12 is a cross-sectional view taken along the direction orthogonal to the exit light axis of the illumination device 80. FIG. 13 is a longitudinal sectional view taken along the direction parallel to the exit light axis of the illumination device 80.

As shown in FIGS. 12 and 13, the illumination device 80 includes the plurality of LED units 23 disposed in a ring shape; a light guide member (light guide section) 81 that is disposed in the inward radial direction of the ring and guides the observation light 24 emitted from an LED unit 23; a reflecting prism (light guide section) 83 that reflects the observation light 24 guided into the light guide member 81; a light-guide-member holding section 84 that supports the light guide member 81 and the reflecting prism 83; a motor 85 (rotating section) that rotationally drives the light-guide-member holding section 84 about the central axis of the ring; a rotation sensor 86 that detects the rotation of the light-guide-member holding section 84; and a control section (not shown in the figure) that controls these components.

The plurality of LED units 23 are arranged in a ring shape and emit beams of the observation light 24 in the inward radial direction of the ring. Furthermore, the LED units 23 emit beams of the observation light 24 having different wavelength ranges for different areas indicated by reference symbols α1, α2, α3, α4, and α5.

The light guide member 81 guides the observation light 24 emitted from an LED unit 23 in the inward radial direction of the ring.

The reflecting prism 83 bends the observation light 24 guided into the light guide member 81 in the direction parallel to the central axis of the ring.

The motor 85 rotationally drives the light guide member 81 and the reflecting prism 83 supported by the light-guide-member holding section 84 together about the central axis of the ring.

The control section controls the illumination of the LED units 23 and the rotation of the motor 85. More specifically, the control section controls the LED units 23 and the motor 85 so that the period and phase for pulsed illumination of the LED units 23 synchronize with the rotation period and phase of the motor 85 detected by the rotation sensor 86 and so that the incident surface of the light guide member 81 faces the pulsed-illuminating LED unit 23.

The basic operation of the illumination device 80 with the above-described structure will be described below.

When the illumination device 80 is started, the motor 85 starts to rotationally drive the light guide member 81 and the reflecting prism 83. When the rotational speed of the motor 85 becomes constant, the control section subjects the LED units 23 facing the incident surface of the light guide member 81 to sequential pulsed illumination in synchronization with the rotation period and phase of the light guide member 81. The observation light 24 that has been emitted from an LED unit 23 and is incident upon the incident surface of the light guide member 81 in this manner is guided by the light guide member 81 in the inward radial direction, is reflected by the reflecting prism 83, and is emitted in the direction parallel to the central axis of the ring. In this manner, the illumination device 80 continuously emits the observation light 24 from the LED units 23 in the direction parallel to the central axis of the ring.

Spectral distribution characteristics of the observation light 24 emitted from the illumination device 80 will be described with reference to FIGS. 14 to 16.

FIG. 14 shows the relationship between a rotational angle θ of the light guide member 81 and the output level of the observation light 24 emitted in the direction parallel to the central axis of the ring. The rotational angle θ indicates a clockwise rotation angle about the central axis of the ring relative to the position at which the incident surface of the light guide member 81 faces the LED unit 23, denoted by reference symbol A1. In FIG. 14, the output levels of the observation light 24 emitted from the LED units 23 disposed in the areas α1, α2, α3, α4, and α5 are represented by A(X), B(λ), C(λ), D(λ), and E(λ), respectively.

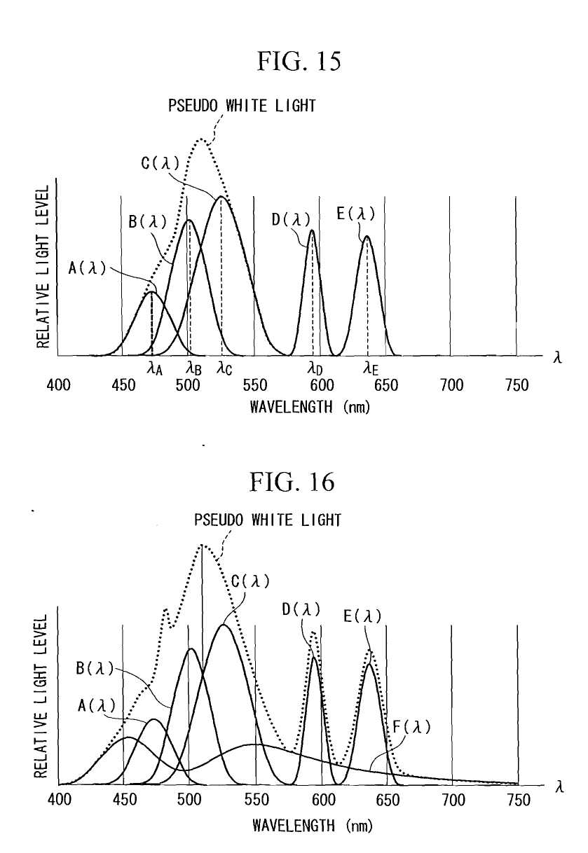

FIG. 15 shows spectral distributions of the observation light 24 emitted from the LED units 23 disposed in the areas α1, α2, α3, α4, and α5. As shown in FIG. 15, pseudo white light can be obtained by combining beams of the observation light 24 emitted from the LED units 23.

As shown in FIG. 16, pseudo white light having a flatter spectral distribution than the pseudo white light shown in FIG. 15 can be obtained by providing a white LED unit that emits white light with an output level indicated by F(λ) in addition to the LED units 23 that emit beams of the observation light 24 with output levels indicated by A(X), B(λ), C(λ), D(λ), and E(λ).

According to the endoscope system 3 of this embodiment, even when the examination site is illuminated by the observation light 24 in the form of pseudo white light having a non-uniform color distribution, as described above, correction can be performed so as to produce a tint equal to the tint of a video signal acquired with the emitted reference light 22 having a flat color distribution to perform display on the display monitor 41.

### Fourth Embodiment

An endoscope system according to a fourth embodiment of the present invention will be described with reference to the drawings.

An endoscope system 4 according to this embodiment differs from the endoscope systems according to the above-described embodiments in the method of calculating the correction coefficients α, β, and γ. For the endoscope system 4 of this embodiment, a description of the same points as those in the above embodiments will be omitted, and points different from those in the above embodiments will be mainly described.

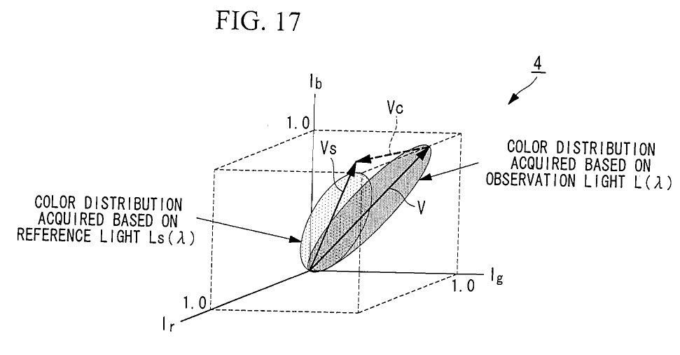

As shown in FIG. 17, correction coefficients that make the color distribution acquired based on the observation light L(λ) equal to the color distribution acquired based on the reference light Ls(λ) are calculated for the normalized values of the respective R, G, and B color components. As the calculation method for this purpose, correction coefficients are calculated based on Expression (10):

Vc(α,β,γ)=Vs−V (10)

where Vc(α,β,γ) represents a correction vector of each of the R, G, and B color components, Vs represents a main-component vector of the color distribution acquired based on the reference light 22, and V represents a main-component vector of the color distribution acquired based on the observation light 24. The magnitudes of these main-component vectors Vs and V are one.

As described above, according to the endoscope system 4 of this embodiment, correction coefficients for making the color distribution Y(Ir) acquired based on the observation light L(λ) approximate the color distribution Ys(Ir) acquired based on the reference light Ls(λ) can be calculated as a correction vector.

### Fifth Embodiment

An endoscope system according to a fifth embodiment of the present invention will be described with reference to the drawings.

An endoscope system 5 according to this embodiment differs from the endoscope systems according to the above-described embodiments in that correction appropriate for the examination site 10 is performed by identifying whether the examination site 10 corresponds to normal tissue or diseased tissue in a living organism. For the endoscope system 5 of this embodiment, a description of the same points as those in the above embodiments will be omitted, and points different from those in the above embodiments will be mainly described.

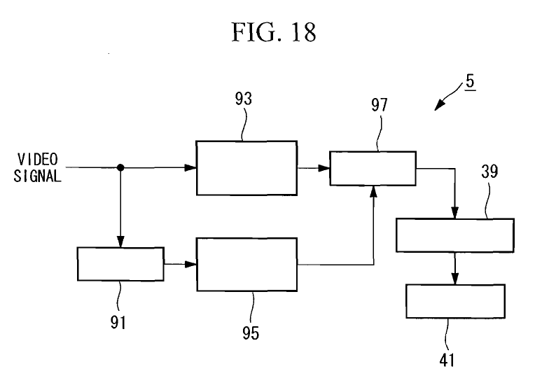

Referring to FIG. 18, in addition to the components shown in FIG. 1, the endoscope system 5 includes an image identifying section 91 that discriminates between normal tissue and diseased tissue; a normal-tissue-color correcting section 93 that corrects the color distribution of a video signal from normal tissue; a diseased-tissue-color correcting section 95 that corrects the color distribution of a video signal from diseased tissue; and a display switching section 97 that switches between the video signal corrected by the normal-tissue-color correcting section 93 and the video signal corrected by the diseased-tissue-color correcting section 95 to output one of the video signals to the display-signal processing section 39.

When the image identifying section 91 determines that the examination site 10 corresponds to normal tissue, the normal-tissue-color correcting section 93 corrects the color distribution of a video signal from the examination site 10 using the first correction coefficients α₁, β₁, and γ₁.

When the image identifying section 91 determines that the examination site 10 corresponds to diseased tissue, the diseased-tissue-color correcting section 95 corrects the color distribution of a video signal from the examination site 10 using the second correction coefficients α₂, β₂, and γ₂.

The display switching section 97 basically outputs the video signal corrected by the normal-tissue-color correcting section 93 to the display-signal processing section 39 and, when the image identifying section 91 detects diseased tissue, outputs the video signal corrected by the diseased-tissue-color correcting section 95 to the display-signal processing section 39.

As described above, according to the endoscope system 5 of this embodiment, the image identifying section 91 can check whether the examination site 10 corresponds to normal tissue or diseased tissue to correct the video signal acquired with the emitted observation light 24 using correction coefficients appropriate for the examination site 10.

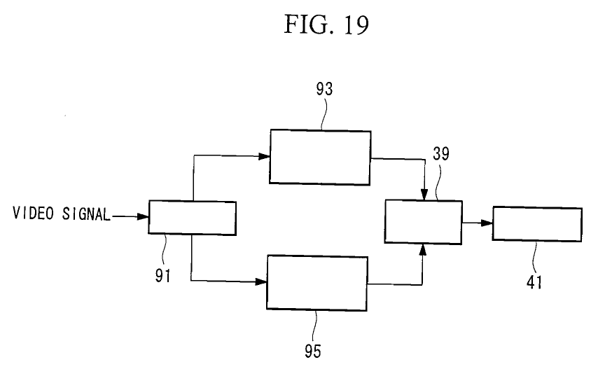

In the above-described endoscope system 5, the image identifying section 91, as shown in FIG. 19, may discriminate between normal tissue and diseased tissue for each predetermined area at a time so that the normal-tissue-color correcting section 93 and the diseased-tissue-color correcting section 95 can correct the video signal acquired with the emitted observation light 24 for each predetermined area at a time.

By doing so, the video signal acquired with the emitted observation light 24 can be corrected based on correction coefficients appropriate for the examination site 10 for each predetermined area at a time, rather than the entire image, thereby more accurately producing a tint equal to that of the image acquired with the emitted reference light 22.

### Sixth Embodiment

An endoscope system according to a sixth embodiment of the present invention will now be described with reference to the drawings.

An endoscope system 6 according to this embodiment differs from the above-described endoscope system 5 in that the color distribution of a video signal is corrected to discriminate between normal tissue and diseased tissue. For the endoscope system 6 of this embodiment, a description of the same points as those in the above embodiments will be omitted, and points different from those in the above embodiments will be mainly described.

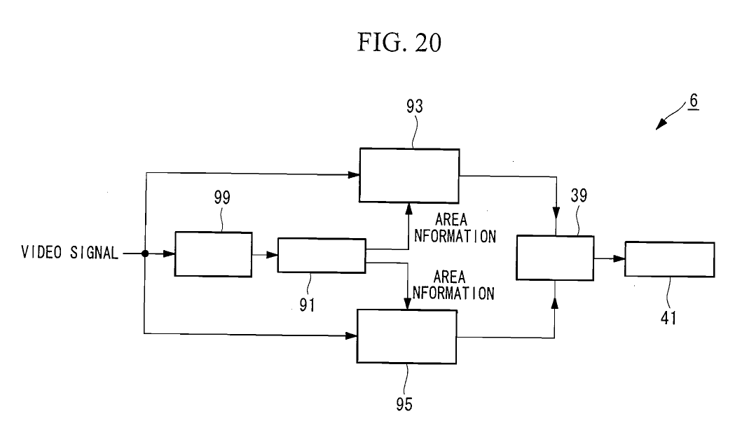

Referring to FIG. 20, in addition to the components shown in FIG. 19, the endoscope system 6 includes an identifying-color correcting section 99 that corrects the color distribution of a video signal to discriminate between normal tissue and diseased tissue.

The operation of the endoscope system 6 with the above-described structure will be described below.

The video signal acquired from the interior of a living organism is input to the identifying-color correcting section 99 and is corrected using third correction coefficients for discriminating between normal tissue and diseased tissue. This correction is intended for facilitating discrimination between normal tissue and diseased tissue and is not intended for producing color equivalent to that of the video signal acquired with the emitted reference light 22. In short, any color correction that is effective in making diseased tissue distinctive to highlight observable specific wavelength ranges is acceptable. For example, if color correction that enhances the luminance of the color range corresponding to the blue narrow-band component and the green narrow-band component is performed, it becomes possible to discriminate between a blood vessel on a mucosal surface and a blood vessel in submucous tissue, helping identify malignant tumors more easily.

A video signal of color-corrected diseased tissue is output from the identifying-color correcting section 99 and is input to the image identifying section 91. In the image identifying section 91, normal tissue is discriminated from diseased tissue to identify areas of normal tissue and diseased tissue. An example method of discriminating between normal tissue and diseased tissue is to identify diseased tissue by identifying areas having a high level of distribution of specific wavelength colors. This method is based on the phenomenon that diseased tissue exhibits a high reflectance in response to specific wavelengths. Information about the identified normal area is input to the normal-tissue-color correcting section, and information about the identified diseased area is input to the diseased-tissue-color correcting section.

Based on the input information about the normal area, the normal-tissue-color correcting section 93 corrects the image of the normal area in the video signal so as to produce a color distribution substantially equal to that resulting from image acquisition with the reference light 22. Similarly, based on the input information about the diseased area, the diseased-tissue-color correcting section 95 corrects the image of the diseased area in the video signal so as to produce a color distribution substantially equal to that resulting from image acquisition with the reference light 22. As a result of these processes of color correction, both the image of the normal area and the image of the diseased area coexisting in the acquired image are corrected to tints substantially equal to those resulting from image acquisition with the reference light 22.

The corrected images output from the normal-tissue-color correcting section 93 and the diseased-tissue-color correcting section 95 are both input to the display-signal processing section 39 together with the area information generated in the image identifying section 91 and are then reconstructed into one image, which is finally displayed on the display monitor 41.

As described above, according to the endoscope system 6 of this embodiment, normal tissue and diseased tissue can be identified with high accuracy, thereby more adaptively performing color distribution correction appropriate for the examination site 10. As a result, an image of normal tissue and diseased tissue acquired with the emitted observation light 24 can be viewed with a tint similar to that of an image acquired with the emitted reference light 22, thereby enhancing the accuracy of tint-based diagnosis.

Although embodiments according to the present invention have been described in detail with reference to the drawings, the present invention is not limited to the specific structures of these embodiments; for example, design changes within the scope of the spirit of the present invention are also encompassed by the present invention.

For example, one item of color distribution data of a video signal acquired with the emitted reference light 22 may be provided for each examination site so that a specific item of color distribution data can be selected according to the intended examination site.

Furthermore, although the present invention has been described assuming that the color distribution acquired based on the reference light 22 is normalized when correction coefficients are to be calculated, it is not always necessary to normalize the color distribution acquired with the observation light 24.

In addition, correction coefficients may be preset as default values and recorded in the correction-coefficient recording section 33.

What is claimed is:

1. An image acquisition apparatus comprising:
an observation light source configured to emit observation light that illuminates an examination site;
an image-acquisition section configured to acquire an image of the examination site illuminated by the observation light emitted from the observation light source;
a correction-coefficient storing section configured to store at least one correction coefficient for making a color distribution of first image information acquired by the image-acquisition section with the emitted observation light approximate a color distribution of second image information acquired by the image-acquisition section with emitted reference light having a flat color distribution;
an image-information correcting section configured to correct the color distribution of the first image information using the at least one correction coefficient stored in the correction-coefficient storing section; and
a display section configured to display the first image information corrected by the image-information correcting section.

2. The image acquisition apparatus according to claim 1, further comprising:
a correction-coefficient calculating section configured to calculate the at least one correction coefficient using the first image information and the second image information.

3. The image acquisition apparatus according to claim 1, wherein
the at least one correction coefficient is a coefficient that minimizes a difference between the color distribution of the first image information and the color distribution of the second image information.

4. The image acquisition apparatus according to claim 1, wherein
the at least one correction coefficient includes a first correction coefficient for correcting a color distribution of image information of normal tissue in a living organism and a second correction coefficient for correcting a color distribution of image information of diseased tissue in the living organism, and
the image-information correcting section corrects the color distribution of the first image information using one of the first correction coefficient and the second correction coefficient.

5. The image acquisition apparatus according to claim 4, further comprising:
an image identifying section configured to discriminate between the normal tissue and the diseased tissue,
wherein the image-information correcting section corrects the color distribution of the first image information using the first correction coefficient if the image identifying section identifies the normal tissue or corrects the color distribution of the first image information using the second correction coefficient if the image identifying section identifies the diseased tissue.

6. The image acquisition apparatus according to claim 5, wherein
the image identifying section discriminates between the normal tissue and the diseased tissue for one predetermined area at a time, and
the image-information correcting section corrects the color distribution of the first image information for each of the predetermined areas at a time.

7. The image acquisition apparatus according to claim 5, wherein
the image identifying section discriminates between the normal tissue and the diseased tissue using a third correction coefficient for correcting the image information of the normal tissue and above-described image information of the diseased tissue so as to produce different color distributions.

8. The image acquisition apparatus according to claim 7, wherein
the third correction coefficient is a coefficient for highlighting a blue narrow-band component and a green narrow-band component.

9. The image acquisition apparatus according to claim 1, wherein the observation light source includes:
a plurality of light source elements that are arranged in the shape of a ring and emit observation light in an inward radial direction of the ring;
a light guide section configured to guide observation light emitted from the light source elements in a direction parallel to a central axis of the ring;
a rotating section configured to rotationally drive the light guide section about the central axis; and
a control section configured to control illumination of the light source elements and rotation of the rotating section.

10. An endoscope system comprising:
the image acquisition apparatus according to claim 1; and,
a scope configured to guide the observation light to the examination site.
